(19) United States
(12) Patent Application Publication
(10) Pub. No.: US 2006/0159506 A1
(43) Pub. Date: Jul. 20, 2006

(54) Keypad module manufacturing method

(76) Inventors: Yung-Fa Cheng, Taipei Shien (TW); Hsiang-Lung Kao, Taipei City (TW)

Correspondence Address: RABIN & BERDO, P.C., Suite 500, 1101 14 Street, N.W., Washington, DC, 20005, US

(21) Appl. No.: 11/184,975

(22) Filed: Jul. 20, 2005

(30) Foreign Application Priority Data
Jan. 14, 2005 (TW) 94101235

(51) Int. Cl. B41J 5/14

(52) U.S. Cl. 400/472

(57) ABSTRACT

A keypad module manufacturing method for reducing production time and enhancing yield is described. A lower substrate, with button holes and positioning holes, is manufactured. A rubber layer is formed upon the lower substrate. An upper substrate, with buttons and a cut-away portion, is manufactured. The upper substrate is attached to the rubber layer on the lower substrate. The cut-away portion is removed from the upper substrate by laser so as to form a keypad module.

### RELATED APPLICATIONS

The present application is based on, and claims priority from, Taiwan Application Serial Number 94101235, filed Jan. 14, 2005, the disclosure of which is hereby incorporated by reference herein in its entirety.

### BACKGROUND

1. Field of Invention

The present invention relates to a keypad module manufacturing method. More particularly, the present invention relates to a keypad module manufacturing method using laser.

2. Description of Related Art

Because of advanced technology, electronic devices, such as mobile phones and PDAs, are getting smaller. Modules of an electronic device are thus reduced in size. For instance, a keypad module is minimized in size as the electronic device served thereby becomes smaller and thinner.

The conventional keypad module manufacturing method involves a lot of manual operations. Each button of a keypad module is usually manufactured individually.

As the keypad module is minimized in size, each button's size is too small in size for a technician to perform a proper manual operation. The technician is thus apt to make mistakes during a conventional keypad module manufacturing process. Production yield of the keypad module is consequently reduced.

### SUMMARY

It is therefore an objective of the present invention to provide a keypad module manufacturing method that reduces production time.

It is another an objective of the present invention to provide a keypad module manufacturing method that eliminates manual operation and to enhances production yield.

In accordance with the foregoing and other objectives of the present invention, a keypad module manufacturing method for reducing production time and enhancing yield is provided. A lower substrate, including button holes and positioning holes, is manufactured. A rubber layer is formed upon the lower substrate. An upper substrate, including buttons and a cut-away portion, is manufactured. The upper substrate is attached to the rubber layer on the lower substrate. The cut-away portion is removed from the upper substrate by laser so as to form a keypad module.

Thus, applying this keypad module manufacturing method should have advantages as follows:

1. Some manufacturing steps can be performed at the same time to save production time;

2. Some manufacturing steps can be arranged in series to save production time; and

3. Manual manufacturing steps are reduced to enhance production yield.

It is to be understood that both the foregoing general description and the following detailed description are examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1A illustrates a perspective view of a keypad module of step 1 according to one preferred embodiment of this invention;

FIG. 1B illustrates a cross-sectional view of keypad module in FIG. 1A;

FIG. 2A illustrates a perspective view of a keypad module of step 2 according to one preferred embodiment of this invention;

FIG. 2B illustrates a cross-sectional view of keypad module in FIG. 2A;

FIG. 3A illustrates a perspective view of a keypad module (square-shaped button) of step 3 according to one preferred embodiment of this invention;

FIG. 3B illustrates a perspective view of a keypad module (round-shaped button) of step 3 according to one preferred embodiment of this invention;

FIG. 4A illustrates a perspective view of a keypad module of step 4 (adding an adhesive layer) according to one preferred embodiment of this invention;

FIG. 4B illustrates a cross-sectional view of keypad module in FIG. 4A;

FIG. 4C illustrates a perspective view of a keypad module of step 4 (attaching an upper substrate to the adhesive layer) according to one preferred embodiment of this invention;

FIG. 4D illustrates a cross-sectional view of keypad module in FIG. 4C;

FIG. 5A illustrates a perspective view of a keypad module of step 5 according to one preferred embodiment of this invention;

FIG. 5B illustrates a cross-sectional view of keypad module in FIG. 5A;

FIG. 6 is a flowchart of a keypad module manufacturing method according to one preferred embodiment of this invention;

FIG. 7A illustrates a perspective view of a lower substrate strip according to another preferred embodiment of this invention;

FIG. 7B illustrates a perspective view of a lower substrate plate according to yet another preferred embodiment of this invention;

FIG. 8A illustrates a perspective view of an upper substrate strip according to another preferred embodiment of this invention;

FIG. 8B illustrates a perspective view of an upper substrate plate according to yet another preferred embodiment of this invention;

FIG. 9A illustrates a perspective view of a lower substrate strip with tooth-shaped clamp sections according to another preferred embodiment of this invention;

FIG. 9B illustrates a perspective view of an upper substrate strip with tooth-shaped clamp sections according to another preferred embodiment of this invention;

FIG. 10A illustrates a perspective view of a keypad module after marking letters or symbols on square-shaped buttons according to one preferred embodiment of this invention; and

FIG. 10B illustrates a perspective view of a keypad module after marking letters or symbols on round-shaped buttons according to one preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In order to resolve the convenience of a conventional keypad module manufacturing method, the present invention provides an enhanced keypad module manufacturing method. Because a lower substrate and an upper substrate are manufactured parallel to each other, production time can be saved.

FIG. 6 illustrates a flowchart of a keypad module manufacturing method according to one preferred embodiment of this invention.

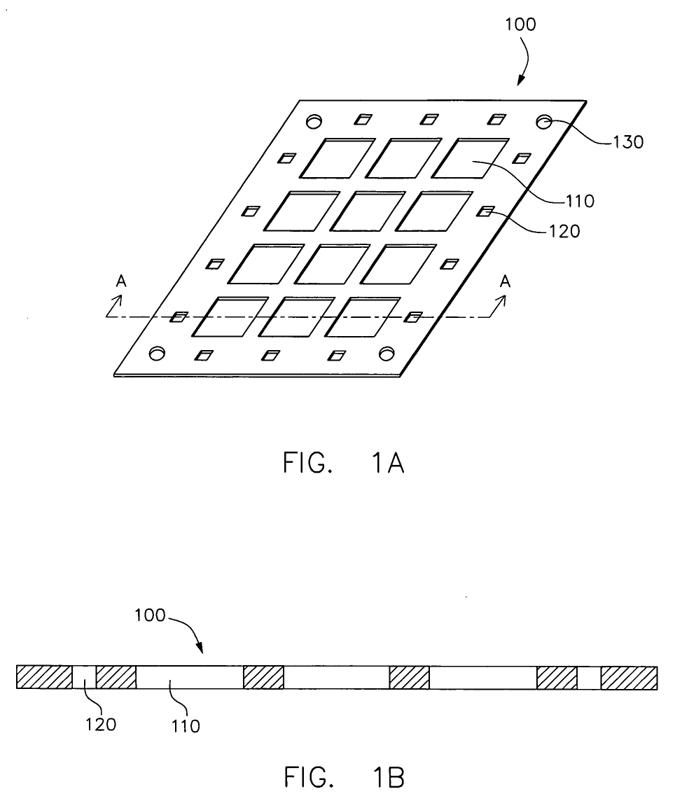

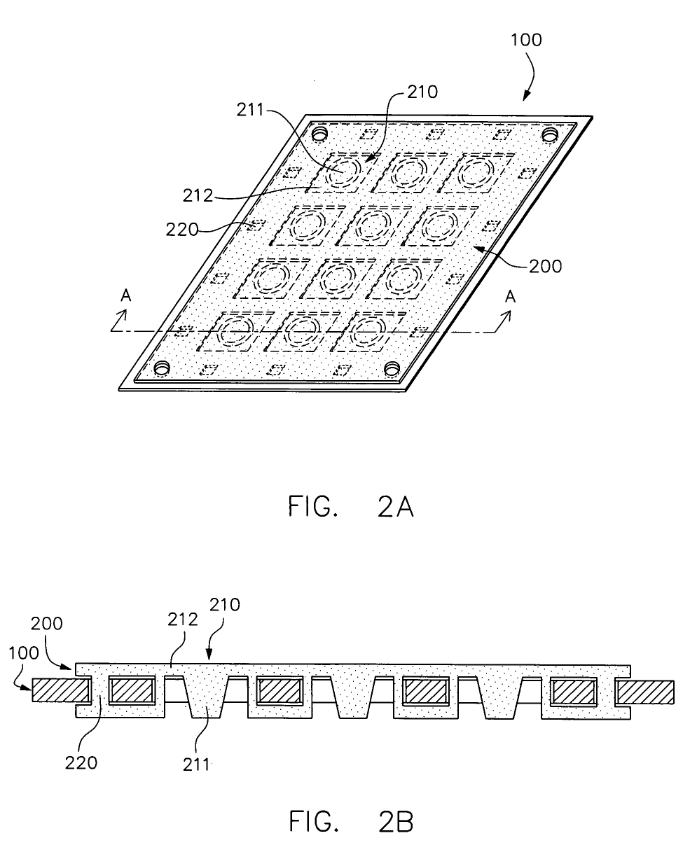

FIG. 1A illustrates a perspective view of a keypad module of step 1 according to one preferred embodiment of this invention. FIG. 1B illustrates a cross-sectional view, taken along A-A in FIG. 1A.

Step 1 is described with reference to FIGS. 1A, 1B and 6. A first substrate 100 can be manufactured by an etching process, a laser cutting process or a mechanical cutting process. A plurality of button holes 110 and positioning holes 120 and module positioning holes 130 are formed in the first substrate 100. Module positioning holes 130 are properly positioned in order to secure the first substrate 100 to a device, such as a mobile phone, a MP3 player, or a PDA. The first substrate 100 is preferably a layer of about 0.2 mm in thickness.

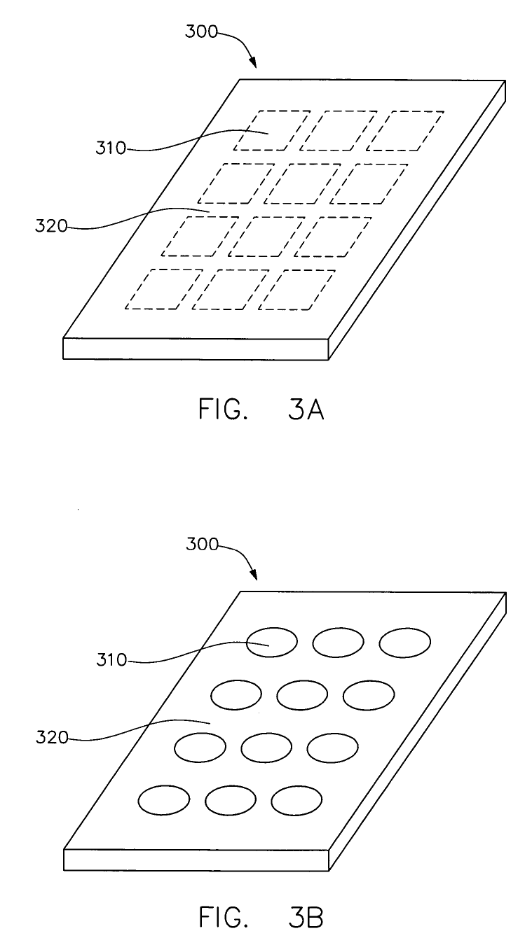

FIG. 2A illustrates a perspective view of a keypad module of step 2 according to one preferred embodiment of this invention. FIG. 2B illustrates a cross-sectional view taken along A-A in FIG. 2A.

Step 2 is described with reference to FIGS. 2A, 2B and 6. A rubber layer 200 is formed on the first substrate 100 by filling liquid rubber into a mold, by which the first substrate 100 has been sandwiched. After baking, the rubber layer 200 is thus secured with the lower substrate 100 as illustrated in FIG. 2A. The rubber layer 200 includes a positioning portion 220 and a buffer portion 210. The buffer portion 210 is formed in the button holes 110 so as to reach a switch on a printed circuit board by contact portion 211 thereof. The positioning portion 220 is formed in the positioning holes 120 to secure the rubber layer 200. A connection portion 212 is formed between the buffer portion 210 and the positioning portion 220. A contact area of the contact portion 211 is preferably the same as that of the switch on the printed circuit board. In this preferred embodiment, the connection portion 212 is preferably 0.6-0.8 mm in length and 0.2 mm in thickness, whereby a comfortable touch feeling is provided.

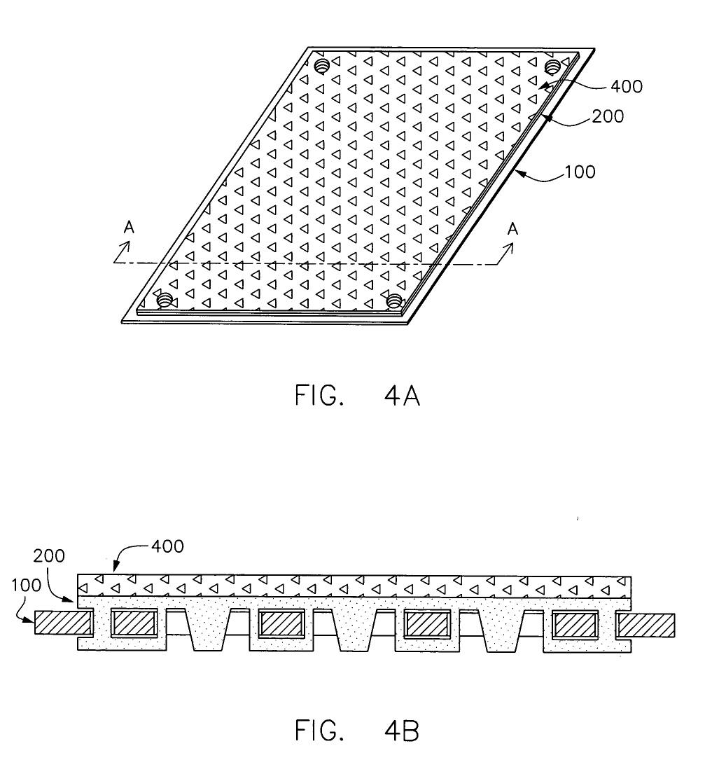

FIG. 3A illustrates a perspective view of a keypad module (square-shaped button) of step 3 according to one preferred embodiment of this invention. FIG. 3B illustrates a perspective view of a keypad module (round-shaped button) of step 3 according to one preferred embodiment of this invention.

Step 3 is described with reference to FIGS. 3A, 3B and 6. A second substrate 300 can be made by trimming a raw material or by mold-projection. Each of buttons 310 is formed on the second substrate 300 according to the corresponding button hole 110 respectively. If the buttons are square (as illustrated in FIG. 3A), the second substrate 300 is preferably made by trimming a raw material. A cut-away portion 320 is removed from the second substrate 300 to form buttons 310. If the buttons are round (illustrated in FIG. 3B), the second substrate 300 is preferably made by mold-projection.

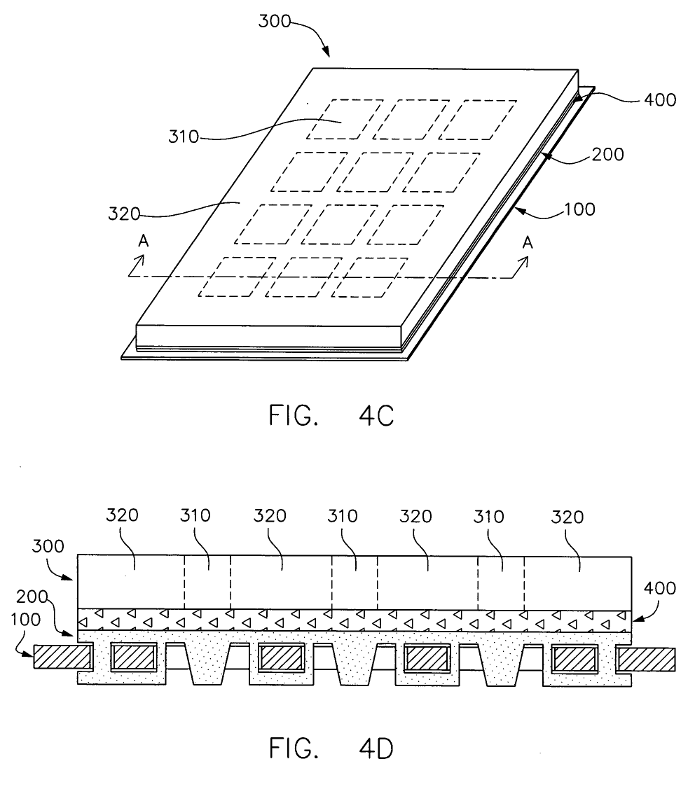

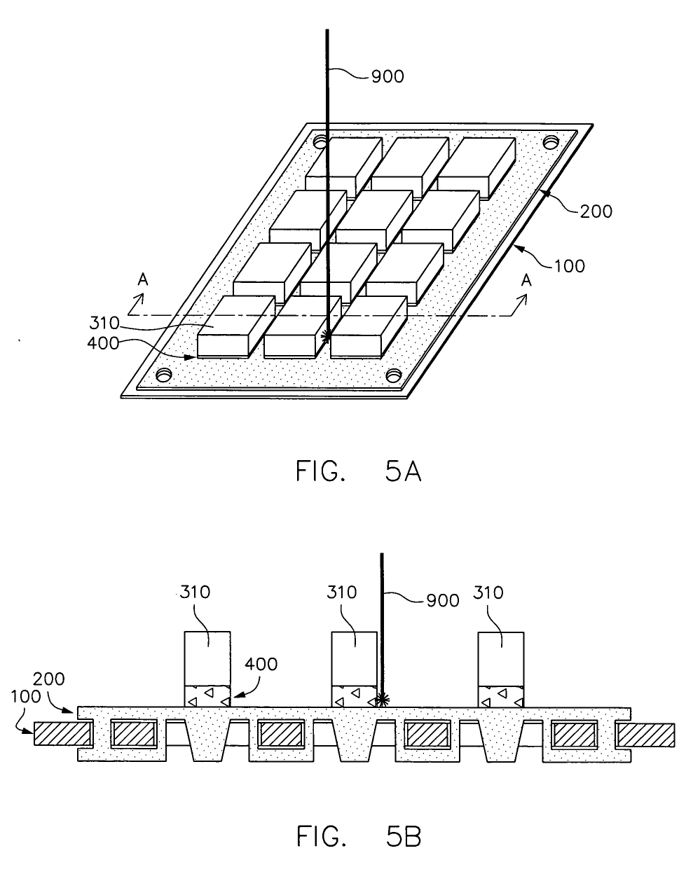

FIG. 4A illustrates a perspective view of a keypad module of step 4 (adding an adhesive layer) according to one preferred embodiment of this invention. FIG. 4B illustrates a cross-sectional view taken along A-A in FIG. 4A. FIG. 4C illustrates a perspective view of a keypad module of step 4 (attaching the second substrate to the adhesive layer) according to one preferred embodiment of this invention. FIG. 4D illustrates a cross-sectional view taken along A-A in FIG. 4C.

Step 4 is described with reference to FIGS. 4A-4D & 6. An adhesive layer 400 is coated on the rubber layer 200. Materials or thickness of the adhesive layer 400 can be adjusted according to layers (i.e. the rubber layer 200 and the second substrate 300) sandwiching the adhesive layer 400. In this preferred embodiment, the adhesive layer 400 is preferably 0.5 mm in thickness. The adhesive layer 400 can be a fast-dry or slow-dry adhesive material and it can be coated on the rubber layer 200 or the second substrate 300. The second substrate 300 is attached to the adhesive layer 400 by aligning its buttons 310 to a corresponding buffer portion 210.

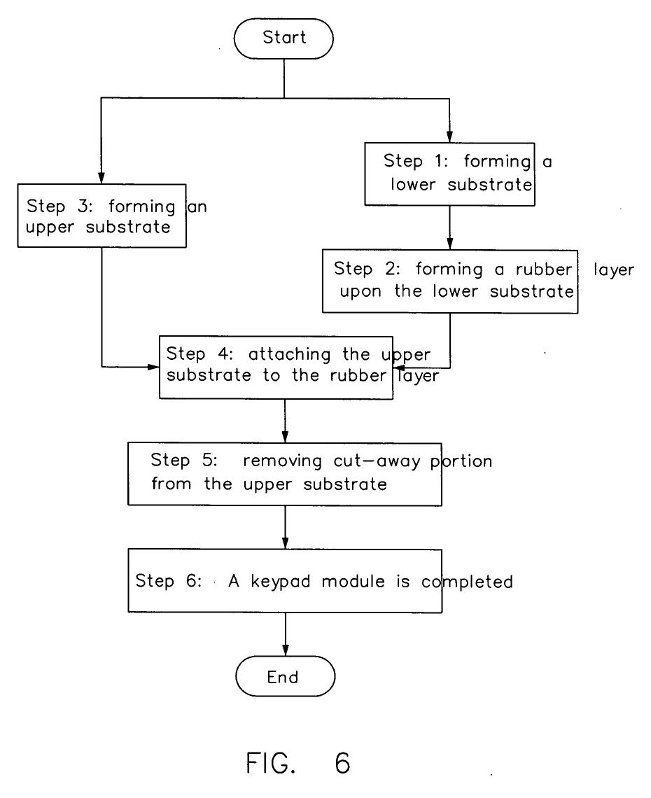

FIG. 5A illustrates a perspective view of a keypad module of step 5 according to one preferred embodiment of this invention. FIG. 5B illustrates a cross-sectional view taken along A-A in FIG. 5A.

Step 5 is described with reference to FIGS. 5A, 5B and 6. After attaching the second substrate 300 to the rubber layer 200, a cut-away portion 320 is removed from the second substrate 300 by means of a laser 900. The laser 900 applies the least stress on interface between the second substrate 300 and the rubber layer 200. Thus, adhesion between the second substrate 300 and the rubber layer 200 is not affected by the laser 900.

In Step 6, after laser processing, a keypad module is completed.

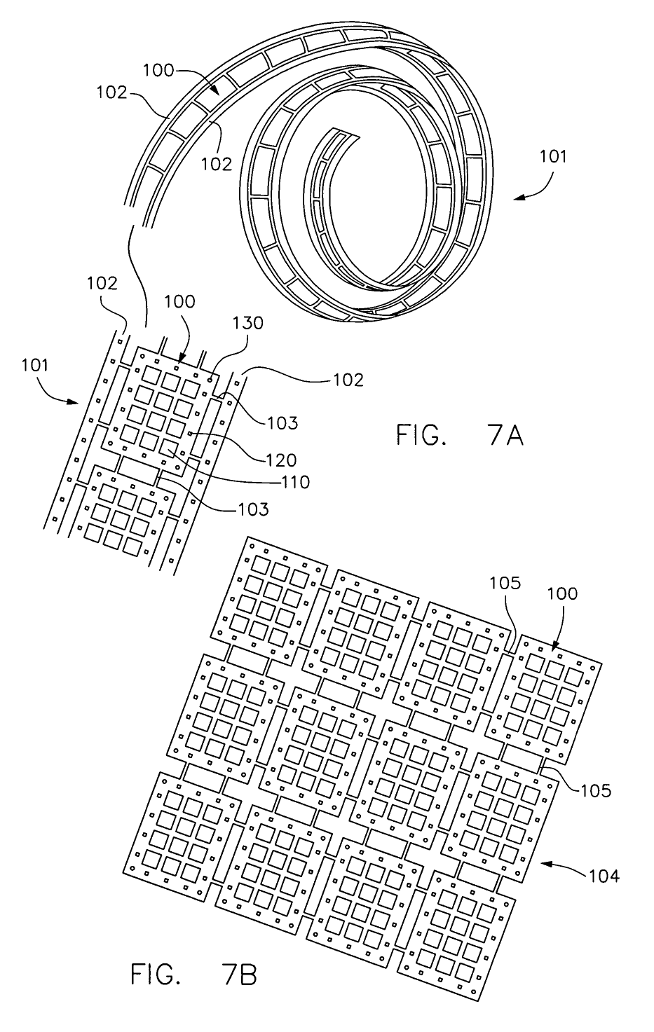

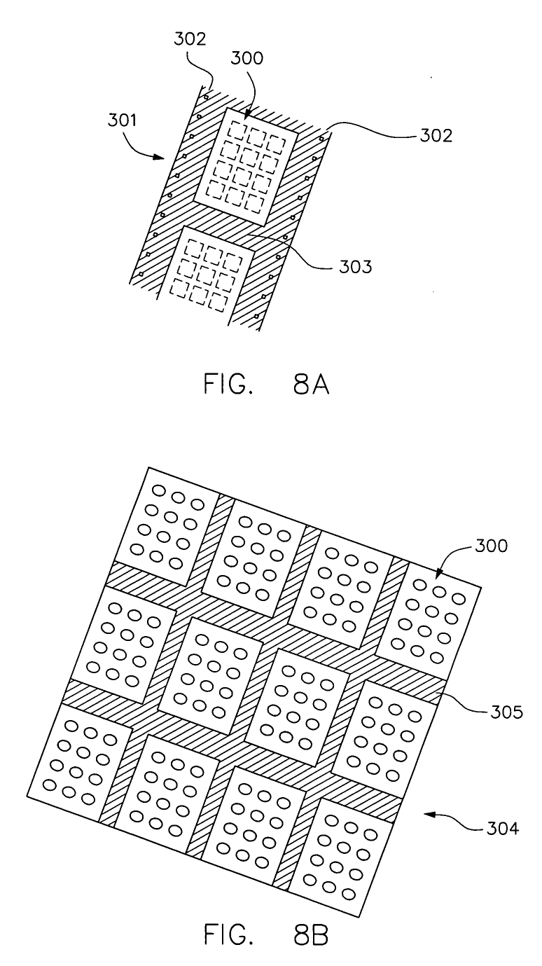

Although the present invention has been described in considerable detail with reference to certain preferred embodiments thereof, other embodiments are possible. For example, the single first substrate 100 of step 1 (illustrated in FIG. 1A) may be replaced by a first substrate strip 101 illustrated in FIG. 7A. Similarly, the single second substrate 300 may be replaced by a second substrate strip 301 illustrated in FIG. 8A.

Referring to FIGS. 7A and 7B, the first substrate strip 101 includes a clamp section 102, links 103, and a series of first substrates 100. The clamp section 102 is positioned at two sides of series of first substrates 100 for mounting on a moving apparatus. The links 103 interconnect first substrates 100 and the clamp section 102. A series of rubber layers is formed on the first substrates 100 while the series of first substrates 100 is moved by the moving apparatus.

Referring to FIGS. 8A and 8B, the second substrate strip 301 includes a clamp section 302, link section 303, and a series of second substrates 300. The clamp section 302 is positioned at two sides of series of second substrates 300 for mounting on a moving apparatus. The link 303 interconnects second substrates 300 and the clamp section 302.

After step 2 and step 3, step 4 is performed. The second substrate strip 301 is attached to the series of rubber layers on the first substrate strip 101 when the second substrate strip 301 and the first substrate strip 101 are moved by the moving apparatus. Meanwhile, in step 5, the cut-away portion is removed from the second substrate strip 301 by means of laser and the second substrate strip 301 is then separated into second substrates 300 by cutting link section 103 using laser.

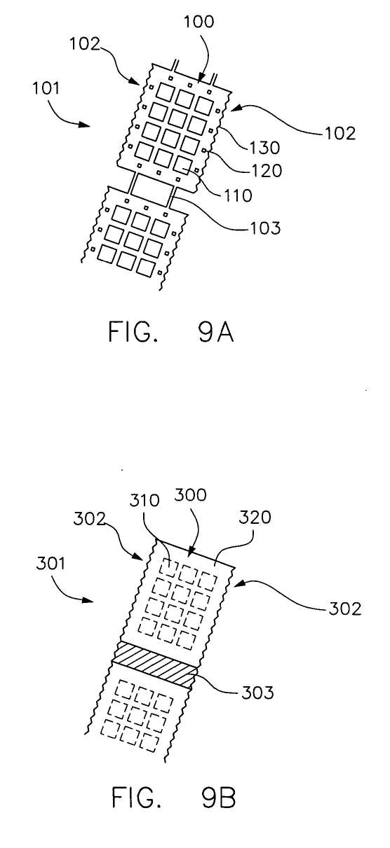

The module positioning holes 130 of the first substrate strip 101 and the second substrate strip 301 can be designed as several different kinds of structures, such as slots or cams. In FIG. 9A, the module positioning holes are replaced by tooth-shaped structures 130, which also serve as a clamp section to be mounted on a moving apparatus. Similarly, in FIG. 9B, the module positioning holes are replaced by tooth-shaped structures 130, which also serve as a clamp section to be mounted on a moving apparatus.

In addition, the single first substrate 100 of step 1 (illustrated in FIG. 1A) may be replaced by a first substrate plate 104 illustrated in FIG. 7B. Similarly, the single second substrate 300 may be replaced by a second substrate plate 304 illustrated in FIG. 8B. Each first substrate 100 of the first substrate plate 104 should be aligned with a corresponding second substrate 300 of the second substrate plate 304.

Referring to FIG. 7B, the first substrate plate 104 includes a plurality of first substrates 100 linked together in rows and columns by links 105. A plurality of rubber layers is formed on each first substrate 100 (step 2).

Referring to FIG. 8B, in step 3, the second substrate plate 304 includes a plurality of second substrates 300 linked together in rows and columns by links 305.

In step 4, the first substrate plate 304 is attached to the rubber layers on the first substrate plate 104. In step 5, the cut-away portion is removed from the second substrate plate 304 by means of a laser, and the second substrate plate 304 is then separated into second substrates 300 by cutting links 305 with a laser.

Buttons 310 of the second substrate 300 can be printed or decorated with different colors or patterns.

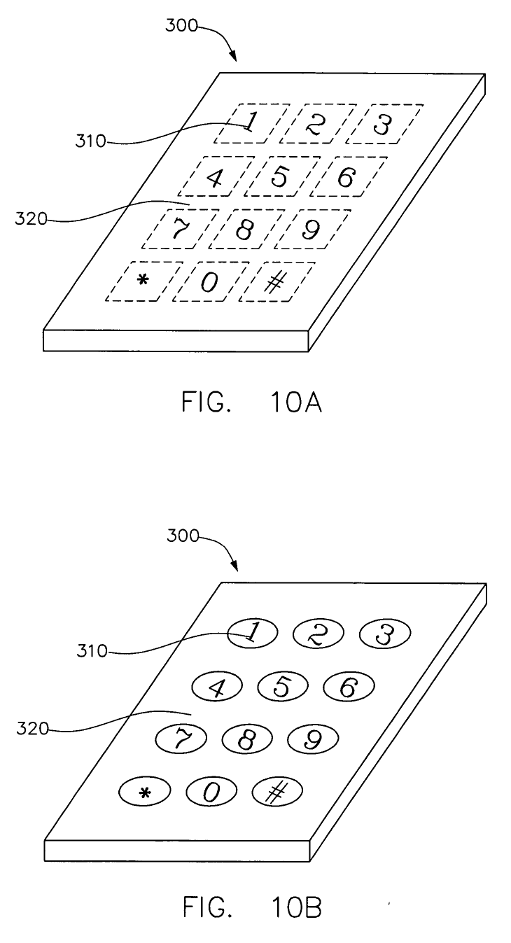

Referring to FIGS. 10A and 10B, buttons 310 of the second substrate 300 can be marked with letters or symbols after step 3, 4, 5 or 6, or before being printed or decorated.

According to preferred embodiments of present invention, applying this keypad module manufacturing method has the following advantages:

1. Some manufacturing steps can be performed at the same time to save production time;

2. Some manufacturing steps can be arranged in series to save production time; and

3. Manual manufacturing steps are reduced to enhance production yield.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A keypad module manufacturing method, comprising:
forming a first substrate, having a plurality of button holes and positioning holes;
forming a rubber layer upon said first substrate;
forming a second substrate, having a plurality of buttons and a cut-away portion thereof, said cut-away portion positioned between said buttons, and each of said buttons matching with a corresponding one of said button holes, attaching said second substrate to said rubber layer; and
removing said cut-away portion from said second substrate to form said plurality of buttons by means of a laser.

2. The keypad module manufacturing method of claim 1, wherein said positioning holes are properly positioned to secure said rubber layer.

3. The keypad module manufacturing method of claim 1, wherein said first substrate is made by mold pressing.

4. The keypad module manufacturing method of claim 2, wherein the step of forming said rubber layer comprising:
forming a buffer portion in said button holes of said first substrate;
forming a contact portion on said buffer portion to reach a switch on a printed circuit board;
forming a positioning portion in said positioning holes; and
forming a connection portion linking said buffer portion and said positioning portion.

5. The keypad module manufacturing method of claim 1, wherein said second substrate is made by trimming a raw material or mold-projection.

6. A keypad module manufacturing method, comprising:
forming a first substrate strip, having a series of first substrates linked together, and a clamp section positioned at two sides of said series of first substrates;
forming a series of rubber layers upon said series of first substrates;
forming a second substrate strip, having a series of second substrates linked together, and a clamp section positioned at two sides of said series of second substrates, each of said second substrates having a plurality of buttons and a cut-away portion thereof, and each of second substrates matching a corresponding one of said first substrates;
attaching said series of second substrates to said series of rubber layers; and
removing said cut-away portion from said series of second substrates to form said plurality of buttons by means of a laser.

7. The keypad module manufacturing method of claim 6, further comprises a step of forming a plurality of button holes and positioning holes in each of said series of first substrates, wherein said positioning holes are properly positioned to secure said rubber layer.

8. The keypad module manufacturing method of claim 6, wherein said first substrate strip is made by mold pressing.

9. The keypad module manufacturing method of claim 7, wherein the step of forming said series of rubber layers comprising:
forming a buffer portion of each of said series of rubber layers in said button holes of said series of first substrates;
forming a contact portion on each of said series of rubber layers to reach a switch on a printed circuit board;
forming a positioning portion of each of said series of rubber layers in said positioning holes of said series of first substrates; and
forming a connection portion linking said buffer portion and said positioning portion.

10. The keypad module manufacturing method of claim 7, wherein each of said buttons is formed in said series of second substrates and corresponding to one of said button holes in said series of first substrates respectively, and said cut-away portion is positioned between said buttons.

11. The keypad module manufacturing method of claim 6, wherein said second substrate strip is made by trimming a raw material or mold-projection.

12. The keypad module manufacturing method of claim 6, wherein the step of attaching said series of second substrates to said series of rubber layers further comprising:
mounting said clamp section of first substrate strip on a moving apparatus and moving said first substrate strip by said moving apparatus, wherein said series of rubber layers is formed upon said series of first substrates continuously while said first substrate strip is moved by said moving apparatus;
mounting said clamp section of second substrate strip on said moving apparatus, and
attaching said series of second substrates to said series of rubber layers while said first and second substrate strips are moved by said moving apparatus.

13. The keypad module manufacturing method of claim 6, further comprising a step of separating said series of first substrates.

14. A keypad module manufacturing method, comprising:
forming a first substrate plate, having a plurality of first substrates linked in columns and rows;
forming a plurality of rubber layers upon said plurality of first substrates;
forming a second substrate plate, having a plurality of second substrates linked in columns, each of said second substrates having a plurality of buttons and a cut-away portion thereof, and each of said second substrates matching a corresponding one of said first substrates;
attaching said plurality of second substrates to said plurality of rubber layers; and
removing said cut-away portion from said plurality of second substrates to form said plurality of buttons by means of a laser.

15. The keypad module manufacturing method of claim 14, further comprising a step of forming a plurality of button holes and positioning holes in each of said plurality of first substrates, wherein said positioning holes are properly positioned to secure said rubber layers.

16. The keypad module manufacturing method of claim 14, wherein said first substrate plate is made by mold pressing.

17. The keypad module manufacturing method of claim 15, wherein the step of forming said plurality of rubber layers comprising:
forming a buffer portion of each of said plurality of rubber layers in said button holes of said plurality of first substrates;
forming a contact portion on each of said plurality of rubber layers to reach a switch on a printed circuit board;
forming a positioning portion of each of said plurality of rubber layers in said positioning holes of said plurality of first substrates; and
forming a connection portion linking said buffer portion and said positioning portion.

18. The keypad module manufacturing method of claim 15, wherein each of said buttons is formed in said plurality of second substrates and corresponding to one of said button holes in said plurality of first substrates respectively, and said cut-away portion is positioned between said buttons.

19. The keypad module manufacturing method of claim 14, wherein said second substrate plate is made by trimming a raw material or mold-projection.

20. The keypad module manufacturing method of claim 14, further comprises a step of separating said plurality of first substrates.
